(19) United States
(12) Patent Application Publication
(10) Pub. No.: US 2007/0234578 A1
(43) Pub. Date: Oct. 11, 2007

(54) Portable handheld work apparatus

(76) Inventors: Johannes Menzel, Wernau (DE); Gunter Wolf, Oppenweiler (DE); Roland Schierling, Affalterbach (DE)

Correspondence Address: WALTER OTTESEN, PO BOX 4026, GAITHERSBURG, MD, 20885-4026, US

(21) Appl. No.: 11/802,351

(22) Filed: May 22, 2007

Related U.S. Application Data
(63) Continuation-in-part of application No. 11/286,398, filed on Nov. 25, 2005, now abandoned.

(30) Foreign Application Priority Data
Nov. 25, 2004 (DE) 10 2004 056 919.3

(51) Int. Cl. B27B 17/02

(52) U.S. Cl. 30/383

(57) ABSTRACT

A portable handheld work apparatus includes: a vibration suppressor for suppressing translatory vibrations occurring during operation of the work apparatus. A drive motor drives the vibration suppressor which defines a rotational axis. The vibration suppressor includes a suppression mass mounted at a radius from the rotational axis for generating an imbalance and, as a consequence of the imbalance, the suppression mass generates an rpm-dependent translatory vibration. A spring applies a resilient biasing force to the suppression mass in opposition to an rpm-dependent centrifugal force applied to the suppression mass during the rotation. The suppression mass is mounted so as to be radially movable along a path under the action of these forces. The suppression mass defines first and second equilibrium positions along the path at first and second radii from the rotational axis corresponding to first and second rpms of the vibration suppressor. The biasing force and the centrifugal force conjointly define a resultant force for effecting an rpm-dependent position transfer of the suppression mass between the first and second equilibrium positions in both directions.

### CROSS REFERENCE TO RELATED APPLICATIONS

This is a continuation-in-part application of U.S. patent application Ser. No. 11/286,398, filed Nov. 25, 2005, and claims priority of German patent application no. 10 2004 056 919.3, filed Nov. 25, 2004, the entire contents of which are incorporated herein by reference.

### FIELD OF THE INVENTION

The invention relates to a portable handheld work apparatus such as a chain saw, cutoff machine, brushcutter or the like.

### BACKGROUND OF THE INVENTION

During operation of work apparatus of this kind, vibrations occur which are excited by a driven tool of the work apparatus. Additional vibrations are excited especially where the drive motor of the work apparatus is in the form of an internal combustion engine because of the moving masses of the engine. In general, these engines are single cylinder engines and have an engine running which is comparatively rough and burdened with vibrations. The vibrations, which are generated at the engine end, cannot be completely eliminated by balancing the moving engine parts. In total, oscillations caused by the tool and engine lead to vibrations which are disturbingly noticeable at the handles of the work apparatus. The handle end vibration can only be reduced to a limited extent with additional measures such as a vibration decoupling of the handles from the engine housing by means of antivibration elements.

U.S. Pat. No. 4,836,297 discloses a portable handheld work apparatus driven by an internal combustion engine wherein imbalance weights are mounted in a crankshaft assembly of the drive motor. An imbalance is deliberately caused by the imbalance weights on the crankshaft web and/or on the fan wheel. The imbalance is so dimensioned with respect to magnitude and phase position that the imbalance, as vibration suppressor, forms a balance or compensation for operation-caused translatory vibrations.

The targeted imbalance of the vibration suppressor results from the imbalance masses which are defined in accordance with phase angle and magnitude. The targeted imbalance of the vibration suppressor can be designed to an optimum of the equivalent oscillation value in order to reduce the vibration level at the handle locations. The imbalance operates to reduce specific oscillation forms from the handle system and from the antivibration system. The equivalent oscillation value results from the values of the representative operating conditions. These values are defined, for example, in motor-driven chain saws as idle rpm values, full-load rpm values and maximum rpm values. It has been shown that a vibration suppressor, which is optimized to the equivalent oscillation value, exhibits an effect which is, under some circumstances, insufficient in the above-mentioned individual operating states.

### SUMMARY OF THE INVENTION

It is an object of the invention to provide a portable handheld work apparatus having a vibration suppressor which is so improved that an improved suppression effect is ensured over a large operating parameter range.

The portable handheld work apparatus of the invention includes: a vibration suppressor for suppressing translatory vibrations occurring during operation of the work apparatus; a drive motor driving the vibration suppressor; the vibration suppressor defining a rotational axis and including a suppression mass mounted at a radius from the rotational axis for generating an imbalance and, as a consequence of the imbalance, the suppression mass generating an rpm-dependent translatory vibration; resilient biasing means for applying a resilient biasing force to the suppression mass in opposition to an rpm-dependent centrifugal force applied to the suppression mass during the rotation; the suppression mass being mounted so as to be radially movable along a path under the action of the forces; the suppression mass defining first and second equilibrium positions along the path at first and second radii from the rotational axis corresponding to first and second rpms of the vibration suppressor; and, the biasing force and the centrifugal force conjointly defining a resultant force for effecting an rpm-dependent position transfer of the suppression mass between the first and second equilibrium positions in both directions.

An arrangement is suggested wherein at least one suppression mass is mounted so as to be radially movable under the force of its rpm-dependent centrifugal force and an opposing spring force. For at least two different rpms of the vibration suppressor, an equilibrium position of the at least one suppression mass is provided in each case with a different radius to the rotational axis. A total force acts on the suppression mass and results from the centrifugal force and the spring force. This total force is provided for an rpm-dependent position change between the two equilibrium positions in both directions. The radial displacement utilizes the situation that the centrifugal force, which acts on the suppression mass, is also directed in the radial direction. In this way, the centrifugal force and the spring force, which acts radially inwardly and in the opposite direction, are used to bring about the rpm-dependent automatic position displacement of the suppression mass without external energy supply. An arrangement is provided which is self acting and adapted to the different operating conditions. This arrangement functions without a separate control unit, without active actuating elements or the like and overall without external intervention. The at least one suppression mass generates a defined imbalance at a first rpm or within a first rpm range. This defined imbalance can effectively suppress translatory vibrations generated at other locations. For a deviating rpm, it was observed that the excitation vibrations to be suppressed change in magnitude and/or phase. However, here the resulting total force, which acts on the suppression mass, changes and moves the suppression mass into a deviating equilibrium position. The changed radius and possibly also the changed phase angle of this additional equilibrium position is so dimensioned that the automatically changed imbalance generates a changed translatory vibration. This vibration is adapted to the rpm-dependent changed excitation vibration in such a manner that both translatory vibrations at least approximately mutually suppress each other. The rpm-dependent position transition between both equilibrium positions takes place in both directions so that an adapted suppression action takes place for rpms which are caused by operation and repeatedly varied, that is, increase and decrease.

In an advantageous embodiment, a radially inner stop is provided for a radially inner equilibrium position of the at least one suppression mass. Alternatively, or in addition, it is advantageous to provide a radially outer stop for a radially outer equilibrium position of the at least one suppression mass. The stop(s) effect a limiting of the movement of the suppression mass. Here, the total force, which acts on the suppression mass, is made up of the centrifugal force and the spring force and also the contact force of the stop. In a specific rpm range, the suppression mass remains fixed in its position. In this way, a fixed non-varying base match of the suppression effect is adjusted within the above-mentioned rpm range.

In a practical embodiment, equilibrium positions are provided which are uniformly distributed in radial direction in addition to or alternatively to the above-mentioned stops and equilibrium positions. These uniformly distributed equilibrium positions variably adjust in dependence upon the rpm because the centrifugal force and the opposing force are there in equilibrium. Without the action of the stops or the like, the radial deflection of the suppression mass changes continuously with the changing rpm. With increasing rpm, the radius of the suppression mass continuously increases whereas the radius continuously decreases with falling rpm. With the selection of a suitable spring characteristic line, a linear or even a nonlinear relationship can be established between rpm and radial deflection of the suppression mass depending upon the operating conditions. Each rpm is assigned a specific position of the suppression mass and therefore also a specific imbalance. At least section wise, a continuous rpm-dependent adaptation of the suppression action can be achieved on the excitation vibration which likewise changes in dependence upon rpm.

It can be practical to permit only a radial deflection of the at least one suppression mass. The rpm-dependent automatic adaptation of the suppressor is limited to a change of the imbalance magnitude. Advantageously, the suppression mass can be additionally arranged with a changing phase angle. The phase angle also changes for an rpm-dependent radial deflection. In this way, the situation can be accounted for that the excitation frequency, which is to be suppressed, can change not only with respect to its magnitude but also with respect to its phase in dependence upon rpm for specific arrangements. With an rpm-dependent phase change of the suppression mass adapted thereto, the suppression action can be further improved.

In a preferred embodiment, the suppression mass is displaceably guided in a translatory guide. Such a translatory guide can be configured in a simple manner, for example, by a simple radial bore in which the suppression mass is slideably held against the force of a spring element. With minimum manufacturing complexity, a precise and reliable arrangement is found which is protected against outside influences. Furthermore, almost any desired number of matching possibilities can be found. The translatory guide can, for example, be exactly radially arranged whereby an exclusively radial guidance of the suppression mass is provided. It is, however, also possible to arrange the translatory guide with radial and tangential directional components, that is, inclined to the radial direction. In this way, a tangential deflection of the suppression mass is additionally provided which is coupled to the radial deflection whereby the imbalance and the suppression action resulting therefrom are changeable not only with respect to their magnitude but also with respect to their phase. It is understood that the translatory guide is not limited to a linear configuration. A curve-shaped displacement path can also be practical which makes possible a nonlinear phase change in dependence upon the radial displacement path. Furthermore, the possibility is present to utilize rubber-elastic pressure-spring elements or the like which have a nonlinear spring characteristic line. The suppression mass can assume intermediate positions in radial and possibly also in tangential direction for specific rpms wherein the centrifugal force and the countering spring force are in equilibrium. Via a targeted adaptation of the nonlinear spring characteristic, a nonlinear displacement path of the suppression mass can also be adjusted in dependence upon the rpm or the centrifugal force resulting therefrom.

In an advantageous embodiment, the suppression mass, which is changeable with respect to its position, is journalled by means of a pivot arm on the vibration suppressor. The pivot arm permits a precise, low wear and robust guidance of the suppression mass.

Advantageously, at least two suppression masses, which are changeable in their positions, are each provided with different ratios of centrifugal force to spring force. The different mass, spring force and/or spring pretensioning are so selected that the individual suppression masses change their positions sequentially in a cascading manner as a function of the rpm. A finely stepped, rpm-dependent displacement of the resulting imbalance in magnitude and phase is also possible which facilitates a finely stepped adaptation to the excitation frequency characteristic.

It is practical to provide one stationary suppression mass and at least one suppression mass which is moveable with respect to its position. A base matching can be achieved with the fixed suppression mass. The suppression masses, which are changeable with respect to their positions, function only to provide the adaptation to rpms which deviate from the base matching. The suppression masses, which are changeable in their positions, can be configured to be correspondingly small whereby a reliable, precise guidance is simplified even at high rpm levels.

In a practical embodiment, the suppression mass, which is changeable in its position, is mounted angularly offset to the stationary suppression mass. Even a radial displacement of the individual suppression masses effects a shift of the total mass center of gravity of the vibration suppressor in magnitude and phase whereby an adaptation of the suppression performance is made possible with kinematically simple means.

The vibration suppressor of the invention can be mounted at different component assemblies of the work apparatus which are rotatably driven. In one embodiment of the drive motor as an internal combustion engine, the vibration suppressor is advantageously mounted on a crankshaft assembly and especially on a fan wheel for generating a cooling air flow. The fan wheel is part of the crankshaft assembly. The coupling of the vibration suppressor to the crankshaft assembly ensures that the vibration suppressor operates with identical rpm or frequency as the excitation oscillations at least of the engine without the constructively provided phase position between excitation vibration and suppressor oscillation being able to change. A permanent suppression action is ensured. The fan wheel has a comparatively large diameter wherein correspondingly small suppression masses can be accommodated without additional need for space.

### BRIEF DESCRIPTION OF THE DRAWINGS

The invention will now be described with reference to the drawings wherein:

FIG. 1 is a perspective overview of a portable handheld work apparatus which is here shown, by way of example, as a chain saw having an internal combustion engine;

FIG. 2 shows a vibration suppressor mounted on the fan wheel of the work apparatus of FIG. 1 with a fixed suppression mass and two suppression masses, which are changeable in position, in a configuration for low rpms;

FIG. 3 shows the arrangement of FIG. 2 with a radially deflected suppression mass at full load;

FIG. 4 shows the arrangement of FIGS. 2 and 3 with both displaceable suppression masses in radially deflected positions at the maximum rpm; and,

FIG. 5 shows a variation of the arrangement of FIGS. 2 to 4 with a suppression mass being linearly displaceable against a spring force at different rpms.

### DESCRIPTION OF THE PREFERRED EMBODIMENTS OF THE INVENTION

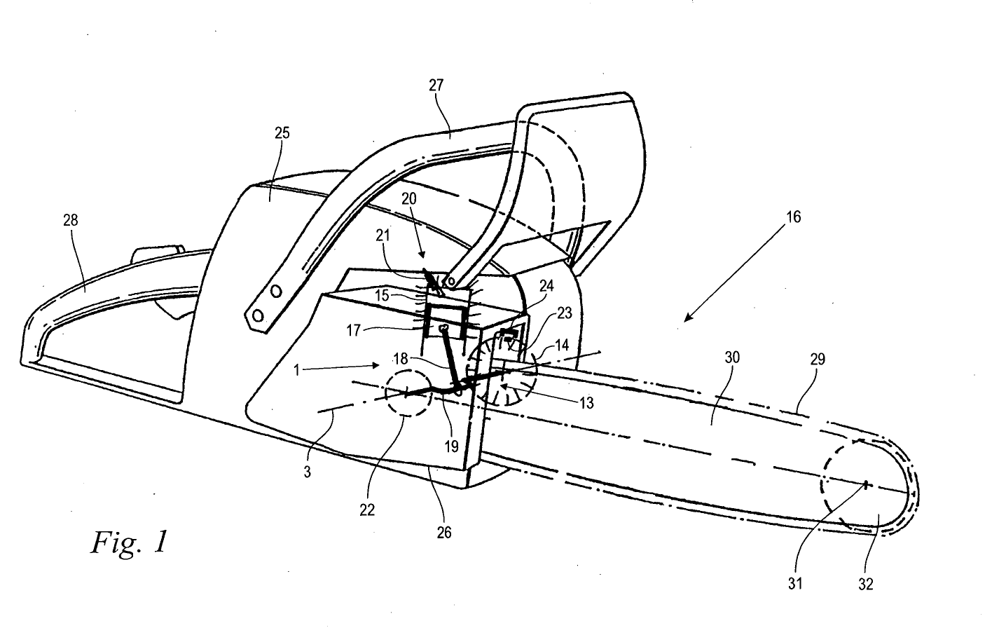

FIG. 1 is a schematic perspective view of a portable handheld work apparatus in the form of a chain saw 16 having a drive motor 1 for driving a saw chain 29. The drive motor 1 is configured as a two-stroke internal combustion engine. Any other desired portable handheld work apparatus, such as a brushcutter or the like, can be provided. The drive motor 1 can also be an electric motor. A two-stroke engine as well as a four-stroke engine can be utilized as the internal combustion engine.

In the embodiment shown, the drive motor 1 has a single cylinder 15 wherein a piston 17 is guided so as to reciprocate in the longitudinal direction. The piston 17 is connected to a crankshaft 19 by a connecting rod 18 for generating a rotational movement about a rotational axis 3.

The saw chain 29 runs along the edges of a guide bar 30. A guide wheel 32, which is rotatable about an axis 31, is provided at the end of the guide bar 30 facing away from the clutch 22 for changing the direction of the saw chain 29. In the region of the end of the guide bar 30 close to the engine, the saw chain 29 engages around a clutch 22 which is attached to an end of the crankshaft 19. The saw chain 29 is driven via the clutch 22 starting at a pregiven rpm of the crankshaft 19.

A fan wheel 14 is at the end of the combustion engine 1 and lies opposite the clutch 22. The fan wheel 14 is for cooling the engine especially in the region of the cylinder 15 and is driven by the crankshaft 19. The fan wheel carries an ignition magnet 23 which passes by a housing-fixed ignition coil 24, which is radially on the outside, with the rotation of the fan wheel. In the ignition coil 24, an ignition voltage is generated for a spark plug 21 mounted in the cylinder 15 whereby an air/fuel mixture in the interior of the cylinder 15 is ignited. Spark plug 21, ignition magnet 23 and ignition coil 24 are parts of an ignition system 20.

The clutch 22, the crankshaft 19 and the fan wheel 14 are fixedly connected to each other. They form a crankshaft assembly 13 with a uniform rpm during operation. The drive motor 1 with its crankshaft assembly 13 is mounted in a motor housing 25. The clutch 22 is covered by a clutch cover 26. Forward and rearward handles (27, 28) are attached to the motor housing 25 for guiding the chain saw 16.

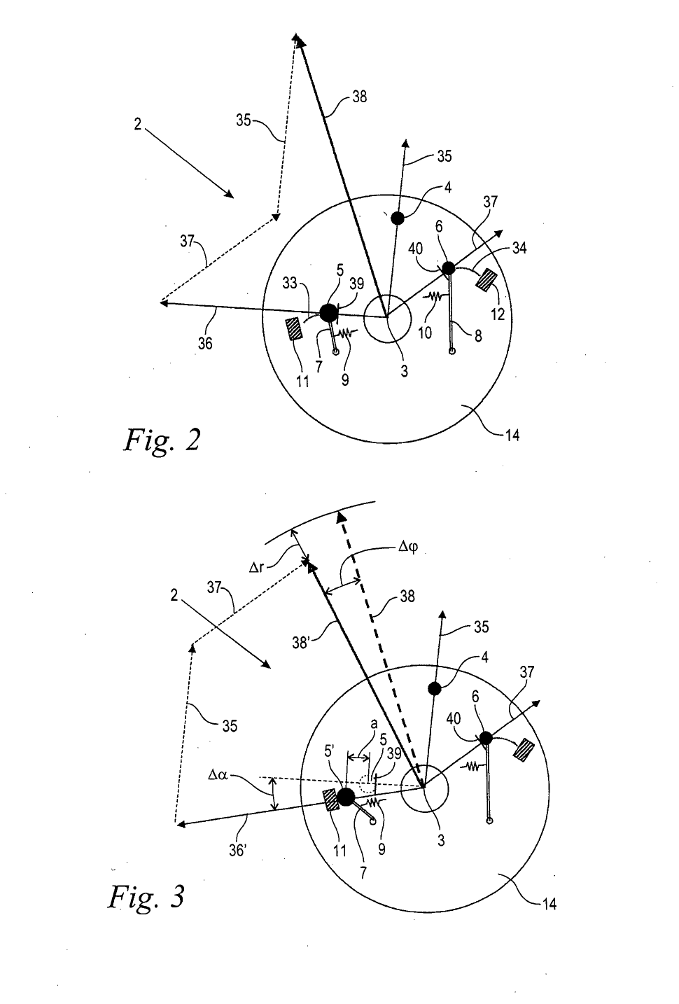

FIG. 2 shows the fan wheel 14 of the crankshaft assembly 13 in a schematic plan view viewed in the direction of the rotational axis 3. The fan wheel 14 is part of the crankshaft assembly 13 of FIG. 1. A vibration suppressor 2 is arranged on the fan wheel 14. During operation of the portable handheld work apparatus, the vibration suppressor 2 rotates about the same rotational axis and at the same rpm as the crankshaft assembly 13 of FIG. 1. The vibration suppressor 2 can also be mounted on the crankshaft 19 or on the clutch 22 (FIG. 1).

In the embodiment shown, the vibration suppressor 2 includes overall three suppression masses (4, 5, 6) for generating a targeted imbalance. The suppression masses (4, 5, 6) are arranged at a radius to the rotational axis 3. With a rotation of the vibration suppressor 2, this imbalance generates an rpm-dependent translatory vibration which is provided to suppress another translatory vibration. Such a translatory vibration, which is to be suppressed can, for example, be brought about by the saw chain 29 (FIG. 1) or another cutting tool because of resonance vibrations of the handles 27 and 28 (FIG. 1) or the like.

The first suppression mass 4 lies fixed on the fan wheel 14. The two additional suppression masses (5, 6) are pivotally journalled on vibration suppressor 2 (that is, the fan wheel 14) by means of respective pivot arms (7, 8). Springs (9, 10) act on the pivot arms (7, 8), respectively, and pull the corresponding pivot arm (7, 8) with the corresponding suppression mass (5, 6) with a spring force under pretension radially inwardly into the position shown. The suppression masses (5, 6) are supported by radially inner stops (39, 40) radially inwardly against the pretensioning force of the springs (9, 10).

The suppression masses (4, 5, 6) generate centrifugal forces with the rotation of the illustrated arrangement at idle rpm and in a mid rpm range. The centrifugal forces are indicated by respective arrows (35, 36, 37) and are directed radially outwardly from the rotational axis 3. The centrifugal forces (36, 37) are not sufficient to overcome the opposing spring forces of the springs (9, 10). Both movable suppression masses (5, 6) are each in a radial inner equilibrium position when contacting against the radially inner stops (39, 40). In these equilibrium positions, the centrifugal forces (36, 37), which spring forces act effectively on the suppression masses (5, 6), and the contact forces at the stops (39, 40) are in equilibrium with each other.

An arrow 38, which shows the resultant centrifugal force, can be formed from a geometric addition of the arrows (35, 36, 37). The suppression masses (4, 5, 6) are shown angularly offset with respect to each other and effect a center of gravity shift of the balanced fan wheel 14 away from the rotational axis 3 radially outwardly in the direction of the arrow 38. It is in this direction of arrow 38 that the resulting imbalance or centrifugal force also acts.

As a consequence of the rotation of the arrangement shown, a translatory oscillation arises which, in magnitude and phase, is so matched to the excitation oscillation of the work apparatus of FIG. 1 that both oscillations mutually cancel or at least approximately mutually cancel in the low rpm range. The translatory oscillation acts within the fan wheel plane or radially to the rotational axis 3.

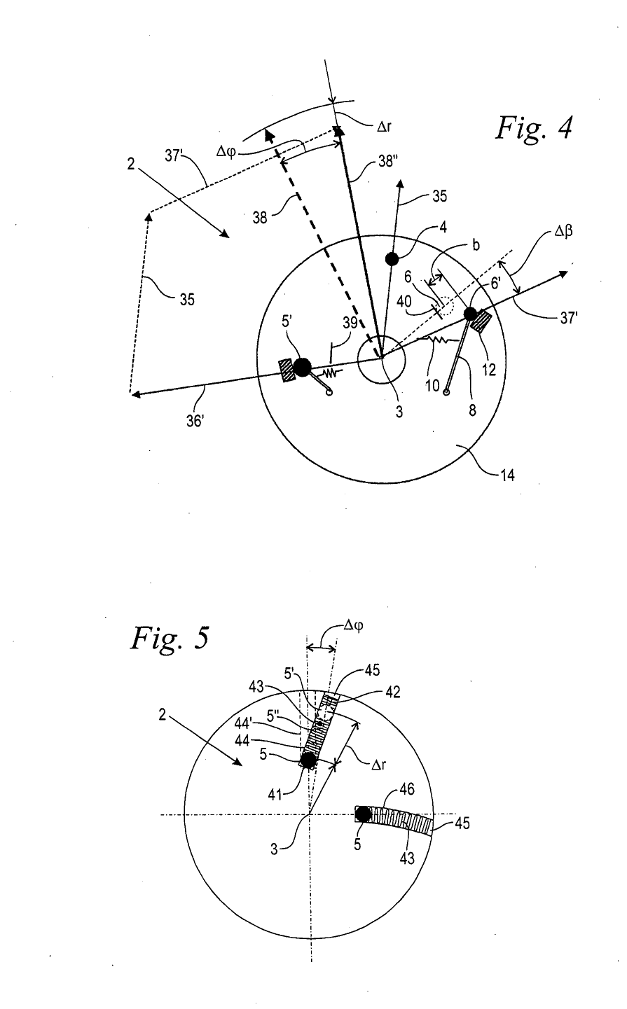

Above constructively predetermined limit rpms, the moveably supported suppression masses (5, 6) can move radially outwardly along arcuately-shaped displacement paths (33, 34). The displacement paths (33, 34) are limited outwardly by assigned stops (11, 12), respectively. When contacting the radial outer stops (11, 12), a further deviating radially outer equilibrium position adjusts wherein the following are in equilibrium with each other: the centrifugal forces of FIGS. 3 and 4; the centrifugal forces acting effectively on the suppression masses (5, 6); and, the contact forces at the stops (11, 12). An rpm-dependent automatic position transition of the suppression masses (5, 6) between these different equilibrium positions is described in detail in the following in connection with FIGS. 3 and 4.

FIG. 3 shows the arrangement of FIG. 2 at full-load operation with mean rpm. At full-load operation, the fan wheel 14 with the vibration suppressor 2 rotates at increased rpm compared to FIG. 2. The application of an external load (for example, on the saw chain 29 (FIG. 1)) causes, however, the full-load rpm to be less than the maximum rpm attainable without load.

The suppression masses (5, 6), the corresponding springs (9, 10) and their stiffnesses, pretensionings and geometric relative arrangement are so matched to each other that a different effective spring pretensioning results at the two suppression masses (5, 6). The effective spring pretensionings are so selected that the centrifugal force, which acts on the suppression mass 5, is sufficient in order to overcome the pretensioning of the assigned spring 9. The total force, which acts on the suppression mass 5, is directed radially outwardly. This total force results from the assigned centrifugal force and the countering spring force. The pivot arm 7 pivots automatically because of the action of the resulting total force in common with the suppression mass 5 from the radial inner equilibrium position into the radial outer equilibrium position identified by reference numeral 5′. This radial outer equilibrium position is radially outwardly delimited by the stop 11. The suppression mass 5′ is displaced with a radial deflection (a) and a phase angle changed by Δα compared to its position shown in FIG. 2 at lower rpm. A centrifugal force, which is shown by arrow 36′, acts on the suppression mass 5′.

The rpm increased relative to FIG. 2 is, however, insufficient to deflect the additional suppression mass 6 via the centrifugal force acting thereon against its higher effective spring pretensioning. The total force at the suppression mass 6, which is put together from the centrifugal force, the spring force and the stop force at the radial inner stop 40, holds the suppression mass in the radial inner equilibrium position. In the scaled diagram shown, the arrows (35, 37) for showing the centrifugal forces have correspondingly not changed in magnitude and direction. These centrifugal forces act on the undisplaced suppression masses (4, 5).

A geometric addition of the arrows (36′, 35 and 37) leads to a resultant centrifugal force or unbalance force (shown by arrow 38′) which is changed by a phase change angle Δφ and a radius Δr relative to the arrow 38 of FIG. 2. This change is adapted to the excitation oscillation changed in magnitude and phase relative to the idle range whereby an improved cancelling or suppression action is achieved.

In the absence of an external load, a further rpm increase can occur up to a maximum rpm. In this situation, a configuration of the vibration suppressor 2 of FIG. 4 results. The increased centrifugal forces caused by rpm, which act on the additional suppression mass 6, are sufficient to overcome the inwardly-directed pretension force of the assigned spring 10. A total force directed radially outwardly occurs at the suppression mass 6 which, similar to the suppression mass 5, brings about an automatic position transition from the radial inner equilibrium position at the stop 40 to the radial outer equilibrium position at the stop 12.

The pivot arm 8 with the suppression mass 6 is deflected radially outwardly up to the position delimited by the stop 12 and identified by reference numeral 6′. Compared to its original position identified by reference numeral 6, the suppression mass 6′ is displaced by a radial deflection path (b) as well as by a deflection angle Δβ. A centrifugal force, which is shown by arrow 37′, acts on the suppression mass 6′. This damping force, when geometrically added to arrows 36′ and 35, leads to a resultant centrifugal force 38″. The phase change angle Δφ relative to the original position of arrow 38 of FIG. 2 runs here in the opposite direction relative to the arrangement of FIG. 3 by way of example. The radial difference Δr which adjusts, is, by way of example, shown with a negative amount. It can also be practical to configure the arrangement so that a longer arrow 38′ and/or 38″ adjusts relative to the original arrow 38 with a positive Δr. The above-mentioned normalized illustration of the centrifugal forces means that the arrows, which are assigned to the centrifugal forces, are an index for the imbalance magnitude of the product of mass and radius, for example, in the unit gmm. The magnitude of the actual imbalance force and the translatory oscillation generated by the vibration suppressor 2 changes with the rpm referred to a fixed imbalance quantity.

The return movement of the suppression masses (5, 6) of FIG. 4, which are deflected into the radial outer equilibrium positions, takes place in the same manner for dropping rpms in the counter direction, that is, in the radial inner equilibrium positions of FIGS. 2, 3; when the rpm drops starting from the maximum rpm of FIG. 4, then also the centrifugal forces (36′, 37′) become less. For an rpm drop below a first limit value, the centrifugal force 37′ becomes less than the effective return force of the spring 10. A total force results which is directed radially inwardly and this total force acts on the suppression mass 6 and results from the centrifugal force 37′ and the spring force. The total force transfers the suppression mass 6 automatically out of the outer equilibrium position into the inner equilibrium position of FIG. 3. For a further drop of the rpm below a second limit value, the centrifugal force 36′ on the suppression mass 5 becomes less than the effective return force of the spring 9. The occurring total force transfers the suppression mass 5 automatically out of its outer equilibrium position of FIG. 3 into the inner equilibrium position of FIG. 2.

In the embodiment of FIGS. 2 to 4, at least equilibrium positions are defined, namely, respective outer and inner equilibrium positions of the suppression masses (5, 6) via the stops (11, 12, 39, 40). For a corresponding design of the springs (9, 10), many equilibrium positions can be generated which are distributed in radial direction or positioned between these stops (11, 12, 39, 40). For specific rpms, the suppression masses (5, 6) can assume intermediate positions wherein, without the action of a stop, the effective centrifugal force and the counter spring force are in equilibrium. For the occurring imbalance, the above applies in the same manner with respect to magnitude and phase.

The embodiment shown has a suppression mass 4, which is fixed on the vibration suppressor 2, and two additional suppression masses (5, 6) which change with respect to their positions. Another number of changeable suppression masses (5, 6) can be practical. Likewise, it can be advantageous to do without a fixed suppression mass 4 and, in total, provide at least one suppression mass (5, 6) changeable with respect to its position.

In the embodiment shown, the suppression masses (5, 6) are so pivotally guided that they change their positions with respect to radius and phase angle in dependence upon the occurring rpm. As a result, a change of the resulting imbalance adjusts with respect to magnitude and phase. A comparable effect can also be obtained with a displacement of the suppression masses (5, 6) which is exclusively radial or exclusively tangential. Leaf springs for supporting and holding the suppression masses (5, 6) can be practical in lieu of the pivot arms (7, 8) and their springs (9, 10). The springs (9, 10) can have any desired configuration. In addition to metal helical springs, leaf springs or spiral springs, also elastic spring bodies made of plastic and especially made of elastomer can be considered.

FIG. 5 shows a variation of the arrangement of FIGS. 2 to 4 with a suppression mass which is displaceable translatorily against a spring force at different rpms. For this purpose, the vibration suppressor 2 has a translatory slide guide for the suppression mass 5. In the embodiment shown, the translatory slide guide is configured as an approximately radial bore 44 which accommodates the suppression mass 5 in the form, for example, of a sphere. In lieu of the bore 44, also a slot, rail or the like can be provided. In lieu of the linear course of the translatory guide shown, it can be practical to provide an arcuately-shaped curved course as shown by way of example with slot 46.

The bore 44 is configured as a blind bore. The radial inner end of the blind bore faces toward the rotational axis 3 and defines a radially inner stop 41 for the suppression mass 5. The radial outer end of the bore 44 is closed with a plug 45 at the peripheral contour of the vibration suppressor 2. A pressure spring 43 is arranged between the stop 45 and the suppression mass 5. The spring force of pressure spring 43 presses the suppression mass 5 radially inwardly toward the inner stop 41. The spring characteristic line of the pressure spring 43 and its pretensioning are matched in such a manner to the suppression mass 5 that the suppression mass 5 remains pressed against the radial inner stop 41 below a lower limit rpm. Here, a first equilibrium position adjusts which is made up of the acting centrifugal force, the spring force and the contact force at the stop 43.

When the lower limit rpm is exceeded, the centrifugal force, which acts on the suppression mass 5, becomes so great that the spring force, which acts in the first equilibrium position, is overcome and the stop force vanishes. The total force, which adjusts, is directed radially outwardly and brings about a displacement path of the suppression mass 5 radially outwardly against the spring force. As a consequence of the radial displacement path, the spring force of the pressure spring 43 increases. For a suitable matching of its spring characteristic line, different equilibrium positions 5″ of the suppression mass adjust wherein the centrifugal force and the countering spring force are in equilibrium. The radial position of the equilibrium position of the suppression mass 5″ increases continuously with increasing rpm or drops continuously with decreasing rpm.

As soon as an upper limit rpm is reached or exceeded, a radial displacement path of the suppression mass 5 adjusts wherein the suppression mass in its radially outer equilibrium position 5′ is pressed against a radial outer stop 42 via the action of the centrifugal force. It can also be practical that the pressure spring 43 is pressed together to the length of a block. The pressure spring 43, which is pressed together to the length of the block, then forms the radial outer stop 42 for the suppression mass. A further advantageous option for all embodiments can be to omit entirely radial inner and/or radial outer stops (11, 12, 39, 40, 41, 42). Radial inner or radial outer equilibrium positions of the suppression mass 5 adjust via the force equilibrium between centrifugal force on the suppression mass 5 and the counter spring force.

The pressure spring 43 is, for example, configured as a metal helical pressure spring. Rubber elastic pressure spring elements, tension spring elements or the like with comparative spring action can also be used. The pressure spring 43 shown has a linear spring characteristic line by way of example. However, a configuration having a nonlinear spring characteristic line can be practical. In this way, an equilibrium position of the suppression mass 5″ can adjust which is adapted to the particular operating conditions and is nonlinear but changes continuously with the rpm.

In the embodiment shown, the bore 44 exhibits an inclination in the peripheral direction in addition to its radial alignment whereby a tangentially directed component of the translatory displacement path is formed. Accordingly, a phase angle change Δφ with any desired intermediate values occurs from the radial displacement path of the suppression mass 5 with the radius difference ΔR between the radial outer equilibrium position and the radial inner equilibrium position. In the case of a linear bore 44, a linear relationship is present between the radial difference ΔR and the phase change angle Δφ. As required, also a nonlinear relationship can be established via a curved translatory guide corresponding to the arcuately-shaped slot 46. A further advantageous option can be to arrange the bore 44 or another suitable translatory guide exclusively in radial direction corresponding to the bore 44′ shown in phantom outline. Here, no phase change angle Δφ results between the different equilibrium positions of the suppression mass 5.

With respect to the remaining features, reference numerals and information as to operation, the embodiment of FIG. 5 corresponds to those of the previously described embodiments.

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
a vibration suppressor for suppressing translatory vibrations occurring during operation of said work apparatus;
a drive motor driving said vibration suppressor;
said vibration suppressor defining a rotational axis and including a suppression mass mounted at a radius from said rotational axis for generating an imbalance and, as a consequence of said imbalance, said suppression mass generating an rpm-dependent translatory vibration;
resilient biasing means for applying a resilient biasing force to said suppression mass in opposition to an rpm-dependent centrifugal force applied to said suppression mass during said rotation;
said suppression mass being mounted so as to be radially movable along a path under the action of said forces;
said suppression mass defining first and second equilibrium positions along said path at first and second radii from said rotational axis corresponding to first and second rpms of said vibration suppressor; and,
said biasing force and said centrifugal force conjointly defining a resultant force for effecting an rpm-dependent position transfer of said suppression mass between said first and second equilibrium positions in both directions.

2. The portable handheld work apparatus of claim 1, further comprising a radially inner stop disposed at said first equilibrium position.

3. The portable handheld work apparatus of claim 2, further comprising a radial outer stop disposed at said second equilibrium position.

4. The portable handheld work apparatus of claim 1, wherein said first and second equilibrium positions are distributed in radial direction in direct dependence upon the rpm of said vibration suppressor with said centrifugal force and resilient biasing force being in equilibrium at said equilibrium positions.

5. The portable handheld work apparatus of claim 1, wherein said suppression mass is mounted so as to permit a changeable phase angle.

6. The portable handheld work apparatus of claim 1, further comprising a translatory guide for displaceably guiding said suppression mass on said vibration suppressor.

7. The portable handheld work apparatus of claim 1, further comprising a pivot arm for pivotally supporting said suppression mass on said vibration suppressor.

8. The portable handheld work apparatus of claim 1, said suppression mass being a first suppression mass and said vibration suppressor further including a second suppression mass movable in position; and, said first and second suppression masses having different ratios of centrifugal force and spring force.

9. The portable handheld work apparatus of claim 1, wherein said vibration suppressor further includes a fixed suppression mass.

10. The portable handheld work apparatus of claim 9, wherein said suppression mass, which is changeable in position, is mounted so as to be angularly offset from said fixed suppression mass.

11. The portable handheld work apparatus of claim 1, wherein said drive motor is an internal combustion engine and said engine has a crankshaft assembly with said vibration suppressor mounted on said crankshaft assembly.

12. The portable handheld work apparatus of claim 11, wherein said crankshaft assembly includes a fan wheel for generating a flow of cooling air for cooling said engine; and, said vibration suppressor is mounted on said fan wheel.

13. A portable handheld work apparatus comprising:
a vibration suppressor for suppressing translatory vibrations occurring during operation of said work apparatus;
a drive motor driving said vibration suppressor;
said vibration suppressor defining a rotational axis and including a suppression mass for generating an imbalance and, as a consequence of rotation, a translatory oscillation;
said suppression mass being mounted at a radius to said rotational axis;
said vibration suppressor further including a mounting arrangement for mounting said suppression mass so as to cause said suppression mass to be changeable in position in dependence upon rpm and as a consequence of the centrifugal force acting on said suppression mass;
said suppression mass being mounted so as to permit a change of radius; and,
said suppression mass being mounted so as to permit a change of phase angle.

14. The portable handheld work apparatus of claim 13, wherein said mounting arrangement includes a pivot arm for pivotally supporting said suppression mass on said vibration suppressor.

15. The portable handheld work apparatus of claim 14, wherein said mounting arrangement further includes: a spring for pretensioning said suppression mass radially inwardly relative to said rotational axis; and, a stop for limiting a deflection path of said suppression mass in a radially outward direction.

16. The portable handheld work apparatus of claim 15, wherein said suppression mass is a first suppression mass and said spring is a first spring having a first pretensioning force; said vibration suppressor includes a second suppression mass; and, said mounting arrangement includes a second spring associated with said second suppression mass and having a pretensioning force different from said first pretensioning force.

17. The portable handheld work apparatus of claim 14, wherein said vibration suppressor further includes a fixed suppression mass.

18. The portable handheld work apparatus of claim 17, wherein said suppression mass, which is changeable in position, is mounted so as to be angularly offset from said fixed suppression mass.

19. The portable handheld work apparatus of claim 13, wherein said drive motor is an internal combustion engine and said engine has a crankshaft assembly with said vibration suppressor mounted on said crankshaft assembly.

20. The portable handheld work apparatus of claim 19, wherein said crankshaft assembly includes a fan wheel for generating a flow of cooling air for cooling said engine; and, said vibration suppressor is mounted on said fan wheel.

21. The portable handheld work apparatus of claim 13, wherein said work apparatus includes a chain saw, cutoff machine, brushcutter or the like.

22. A portable handheld work apparatus comprising:
a vibration suppressor for suppressing vibrations occurring during operation of said work apparatus;
a drive motor driving said vibration suppressor;
said vibration suppressor defining a rotational axis and including a suppression mass for generating an imbalance;
said suppression mass being mounted at a radius to said rotational axis;
said vibration suppressor further including a mounting arrangement for mounting said suppression mass so as to cause said suppression mass to be changeable in position in dependence upon rpm; and,
said suppression mass being mounted so as to permit a change of phase angle.

23. A portable handheld work apparatus comprising:
a vibration suppressor for suppressing vibrations occurring during operation of said work apparatus;
a drive motor driving said vibration suppressor;
said vibration suppressor defining a rotational axis and including a suppression mass for generating an imbalance;
said suppression mass being mounted at a radius to said rotational axis;
said vibration suppressor further including a mounting arrangement for mounting said suppression mass so as to cause said suppression mass to be changeable in position in dependence upon rpm; and,
said mounting arrangement including a pivot arm for pivotally supporting said suppression mass on said vibration suppressor.

24. A portable handheld work apparatus comprising:
a vibration suppressor for suppressing vibrations occurring during operation of said work apparatus;
a drive motor driving said vibration suppressor;
said vibration suppressor defining a rotational axis and including a suppression mass for generating an imbalance;
said suppression mass being mounted at a radius to said rotational axis;
said vibration suppressor further including a mounting arrangement for mounting said suppression mass so as to cause said suppression mass to be changeable in position in dependence upon rpm;
said suppression mass being mounted so as to permit a change of radius; and,
said suppression mass being mounted so as to permit a change of phase angle.

25. The portable handheld work apparatus of claim 24, wherein said mounting arrangement includes a pivot arm for pivotally supporting said suppression mass on said vibration suppressor.

26. The portable handheld work apparatus of claim 25, wherein said mounting arrangement further includes: a spring for pretensioning said suppression mass radially inwardly relative to said rotational axis; and, a stop for limiting a deflection path of said suppression mass in a radially outward direction.

27. The portable handheld work apparatus of claim 26, wherein said suppression mass is a first suppression mass and said spring is a first spring having a first pretensioning force; said vibration suppressor includes a second suppression mass; and, said mounting arrangement includes a second spring associated with said second suppression mass and having a pretensioning force different from said first pretensioning force.

28. The portable handheld work apparatus of claim 25, wherein said vibration suppressor further includes a fixed suppression mass.

29. The portable handheld work apparatus of claim 28, wherein said suppression mass, which is changeable in position, is mounted so as to be angularly offset from said fixed suppression mass.
